(19) United States
(12) Patent Application Publication
(10) Pub. No.: US 2007/0170315 A1
(43) Pub. Date: Jul. 26, 2007

(54) Method of detecting obstacles on railways and preventing train accidents

(76) Inventors: Gedalyahu Manor, Haifa (IL); Oded Yanku, Lotem (IL); Tai Israely, Haifa Bay (IL); David Barkan, Haifa (IL)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/654,920

(22) Filed: Jan. 18, 2007

Related U.S. Application Data
(60) Provisional application No. 60/760,781, filed on Jan. 20, 2006.

(51) Int. Cl. B61L 3/00; H04N 7/18; B60Q 1/00

(52) U.S. Cl. 246/167 R; 340/435; 348/148

(57) ABSTRACT

The object of the invention is to provide a method and an apparatus for detecting obstacles on railways and stopping the train to prevent collision with the obstacle. The detecting device in or on the train is following the rails and detecting any obstacle on the rails. The image of the rails with obstacle is sent to a computer, analyzed, directing the detecting device to the rails and sending the images to a monitor and alarm the driver by an alarming system to actuate the brakes and stop the train before hitting the obstacle. The computer may also actuate the brakes automatically and stop the train before hitting the obstacle.

This application claims the benefit of provisional application Ser. No. 60/760,781 filed Jan. 20, 2006

### BACKGROUND OF THE INVENTION

The invention relates to a method and equipment for detecting obstacles on railways and stopping the train to prevent collision with the obstacle. Train collision with obstacles on the rails are causing damage to the train and injuries to people involved, mainly if the obstacle is a vehicle trying to cross, while the train is approaching. The train cannot stop in a short distance, as the friction between its wheels and the rails is very low. Because of that there is a need to detect obstacles on the rails a long distance in front of the train.

It is an object of the invention to provide a method and apparatus for detecting obstacles on railways and stopping the train to prevent collision with the obstacle.

### SUMMARY OF THE INVENTION

The invention provides a method for detecting obstacles on railways, i. e., straight portions and curved portions, and stopping the train to prevent collision with the obstacle.

In a preferred embodiment one of the detecting system is at least one device, mounted in or on the train, to capture the image of the railway in front of the train, far enough to stop the train, manually or automatically, before hitting the obstacle detected by the device.

In a preferred embodiment the detecting devices are day-night cameras, connected to the train computer, to show the rails and an obstacle, if exists, on a monitor and to activate a siren for the driver to stop the train, or even stop the train automatically when detecting an obstacle.

In another preferred embodiment the detecting devices are radar devices, connected to the train computer, to scan the rails and detect an obstacle, if exists, onto a monitor and to activate a siren for the driver to stop the train, or even stop the train automatically when detecting an obstacle.

In another preferred embodiment the detecting devices are laser devices, connected to the train computer, to scan the rails and detect an obstacle, if exists, onto a monitor and to activate a siren for the driver to stop the train, or even stop the train automatically when detecting an obstacle.

In another preferred embodiment the detecting devices are using ultrasonic detectors or any other type.

### BRIEF DESCRIPTION OF THE DRAWINGS

FIG. 1 is an upper view of a train running on rails with an obstacle in front of it.

FIG. 2 is a side view of a train running on rails with an obstacle in front of it.

FIG. 3 shows a monitor with the image of the rails on its center and an image of an obstacle on the image of the rails.

FIG. 4 is a schematic diagram of the control system of the obstacle detection and train stopping system.

### DETAILED DESCRIPTION

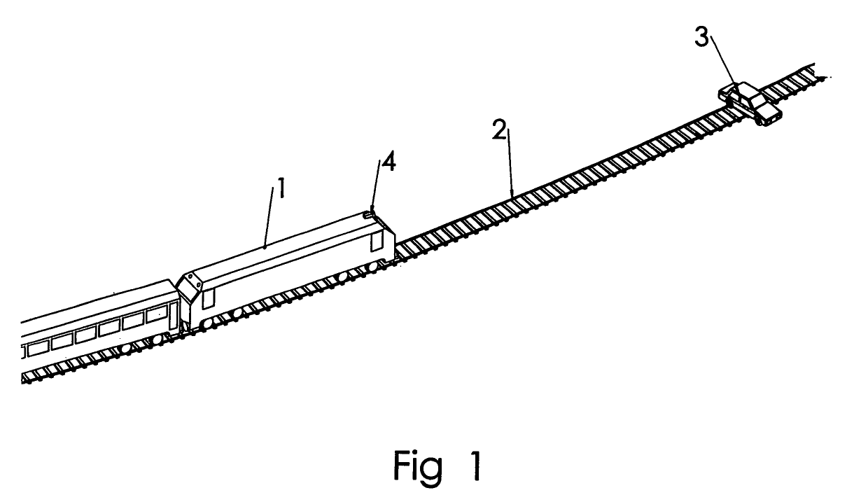

FIG. 1 is an upper view of a train 1 running on rails 2 with an obstacle 3 in front of it. A detecting device 4 on the train 1 is following the rails 2 and detecting any obstacle 3 on the rails 2.

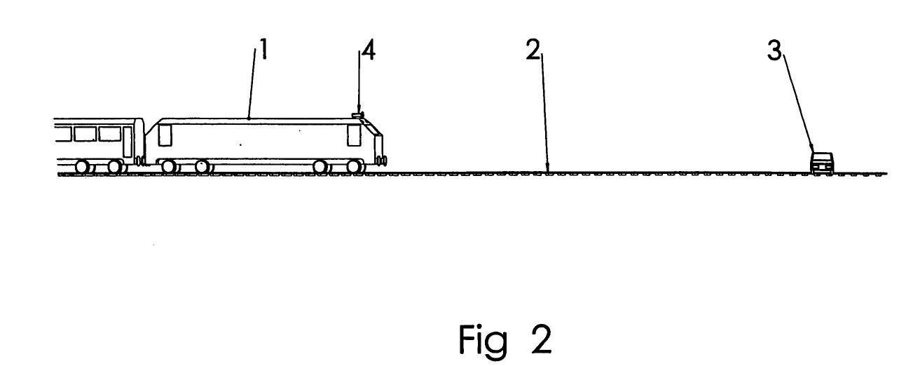

FIG. 2 is a side view of a train 1 running on rails 2 with an obstacle 3 in front of it. A detecting device 4 on front of the train 1 is following the rails 2 and detecting any obstacle 3 on the rails 2.

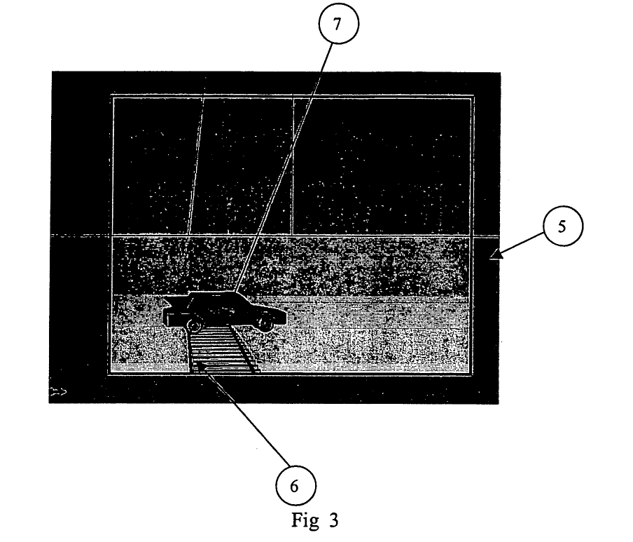

FIG. 3 shows a monitor 5 with the image of the rails 6 on its center and an image of an obstacle 7 on the image of the rails 6, as was captured by the detecting device 4.

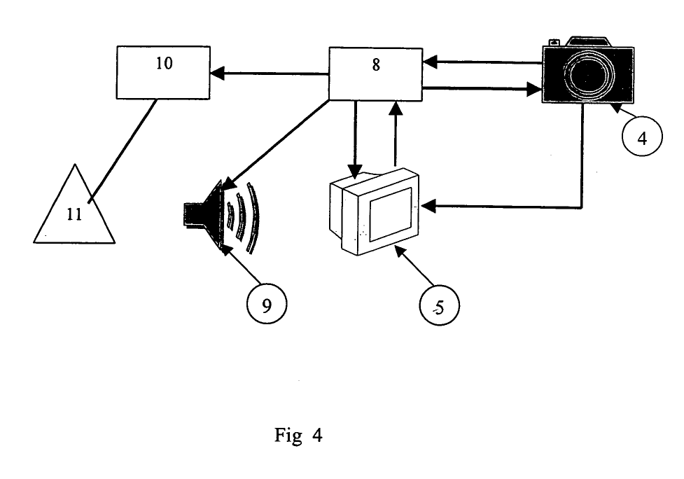

FIG. 4 is a schematic diagram of the control system of the obstacle detection and train stopping system. The detecting device 4 in or on the train 1 is following the rails 2 and detecting any obstacle 3 on the rails 2. The image of the rails 6 is sent to the computer 8, analyzed, directing the detecting device 4 to the rails 2 and sending the images 6 and 7 to the monitor 5. The detecting device 4 is automatically directed, by the computer, to the rails 2 far enough to stop the train before hitting a detected obstacle 3. When the detecting device 4 detects an obstacle 3, the image is sent to the computer 8, which sends the image of the obstacle 7 to the monitor 5, and alarm the driver 11 by alarming system 9 to actuate the brakes 10 and stop the train 1 before hitting the obstacle 3. The computer 8 may also actuate the brakes 10 automatically and stop the train 1 before hitting the obstacle 3.

1. A method for detecting obstacles on railways and stopping the train to prevent collision with the obstacle comprising:
at least one detecting device in or on the train to follow the rails and take images while running,
a computing system to analyze the images of the rails and detecting the rails and any obstacle on them,
a monitor to show the images of the rails and a detected obstacle,
an alarm system to be actuated when an obstacle is detected,
a braking system of the train.

2. The method of claim 1, wherein said at least one detecting device is a day-night, camera.

3. The method of claim 1, wherein said at least one detecting device is a radar device.

4. The method of claim 1, wherein said at least one detecting device is a laser device.

5. The method of claim 1, wherein said at least one detecting device is an ultrasonic detector or any other type.

6. The method of claim 1, wherein said braking system of the train is manually operated.

7. The method of claim 1, wherein said braking system of the train is automatically operated when an obstacle is detected.

8. A detecting system for detecting obstacles on railways and stopping the train to prevent collision with the obstacle comprising:
at least one detecting device in or on the train to follow the rails and take images while running,
a computing system to analyze the images of the rails and detecting the rails and any obstacle on them,
a monitor to show the images of the rails and a detected obstacle,
an alarm system to be actuated when an obstacle is detected,
a braking system of the train.

9. The detecting and stopping system of claim 8 wherein said at least one detecting device is a day-night camera.

10. The detecting and stopping system of claim 8 wherein said at least one detecting device is a radar device.

11. The detecting and stopping system of claim 8 wherein said at least one detecting device is a laser device.

12. The detecting and stopping system of claim 8 wherein said at least one detecting device is an ultrasonic detector or any other type of detector.

13. The detecting and stopping system of claim 8 wherein said alarming system is of any type.

14. The detecting and stopping system of claim 8 wherein said braking system of the train is manually operated by the alarmed operator, before hitting a detected obstacle.

15. The detecting and stopping system of claim 8 wherein said braking system of the train is automatically operated when an obstacle is detected.
